(19) United States
(12) Patent Application Publication
(10) Pub. No.: US 2011/0284356 A1
(43) Pub. Date: Nov. 24, 2011

(54) Keypad plunger structure and method of making the same

(76) Inventor: Shao-Hua Lan, Taoyuan (TW)

(21) Appl. No.: 12/889,384

(22) Filed: Sep. 23, 2010

(30) Foreign Application Priority Data
May 20, 2010 (TW) 099116101

(51) Int. Cl. H01H 13/78; B29C 47/02; B32B 37/16

(52) U.S. Cl. 200/5 A; 156/292; 156/245

(57) ABSTRACT

A keypad plunger structure and a method of making the keypad structure, in which, a polymer film (such as a PET film) and a plunger material layer (such as a silicone rubber) are co-molded to form a co-molded article including the polymer film and a plurality of plungers. The co-molded article is utilized to attach a plurality of metal domes on a printed circuit board through an adhesive layer. The plungers are located correspondingly to the metal domes. Before the co-molding process, the other side of the polymer film may be combined with an adhesive and a release paper, which further facilitates the manufacturing process.

### BACKGROUND OF THE INVENTION

1. Field of the Invention

The present invention relates to a keypad plunger structure and a method of making the keypad plunger structure, and particularly to a thin-type keypad plunger structure and a method of making the same.

2. Description of the Prior Art

Electronic products such as telephones, cell phones, smart phones, personal digital assistants (PDAs), mobile internet device (MID), electronic translators and the like usually have keypad keyboards. As the 3C products are demanded to be thin by the market, ultra-thin keys are increasingly developed.

A conventional keypad structure has a structure or structures of plungers. The plungers are combined with a base layer under keycaps. Metal domes are further disposed on a printed circuit board and the metal domes are attached to the printed circuit board by a dome sheet for fixture. When a keytop is pressed, the force transferred from the keytop to the plunger and down to the metal dome thereunder. The metal dome is accordingly deformed to contact an electrical connection site of the printed circuit board to form an electric circuit. However, since there is an assembly inaccuracy for the assembly of the plunger and the metal dome, the plunger and the top of the center of the metal dome are not accurately aligned, and this makes the force transferred to the metal dome deviate. As a result, the metal dome is not accurately deformed, and it becomes an issue that the metal dome is not able to contact the electrical connection site.

For solving the issue due to the assembly inaccuracy as described above, Japanese patent application publication No. 2008-269864 discloses a keypad structure, in which, the plungers are attached to a dome sheet, or the plungers and the dome sheet are formed integrally. Alight reflection mechanism may be disposed on one side of the dome sheet to reflect the backlight. Key patterns may be printed on the other side. Japanese patent application publication No. 2009-117222 discloses a keypad structure, in which the plungers are attached to a dome sheet through an adhesive layer. However, it may be tedious to attach so many of singular plungers to the dome sheet one by one. In other hand, if the plungers and the dome sheet are formed integrally, the material and the size are not easily matched to each other as desired since each have to have its own properties to meet the demand.

Therefore, there is still a need for a novel keypad structure and a method of making the same which meets the thin type requirement and still provides good pressing feeling.

### SUMMARY OF THE INVENTION

One objective of the present invention is to provide a method of making a keypad plunger structure and a keypad plunger structure which is relatively thin and gives a uniform key press feeling.

In one aspect, the method of making a keypad plunger structure according to the present invention comprises steps as follows. A printed circuit board is provided. A co-molded article is provided. The co-molded article includes a polymer film and a plunger layer. The plunger layer includes a plurality of plungers. The polymer film has a first side and a second side. The plunger layer is attached to the first side of the polymer film. The co-molded article is employed to attach a plurality of metal domes to the printed circuit board in a way that the plungers are disposed at locations corresponding to the metal domes, respectively. A keycap structure is disposed above the co-molded article.

In another aspect, the keypad plunger structure according to the present invention includes a printed circuit board, a plurality of metal domes, a co-molded article, a thermoplastic polyurethane (TPU) layer and a plurality of keytop components. A plurality of electrical connection sites are disposed on the printed circuit board. A plurality of metal domes are correspondingly disposed above the electrical connection sites respectively. When each of the metal domes is pressed, it is electrically connected to the electrical connection site thereunder. The co-molded article includes a polyethylene terephthalate (PET) film and a plunger layer having a plurality of plungers. The co-molded article is allowed to cover the metal domes and is combined with the metal domes through an adhesive layer together to attach to the printed circuit board to fix the metal domes on the printed circuit board. The plungers are located above the metal domes respectively. The TPU layer is disposed on the co-molded article. A plurality of keytop components are attached to the TPU layer corresponding to the locations of the plungers.

In further another aspect, the keypad plunger structure according to the present invention includes a printed circuit board, a plurality of metal domes, a co-molded article, a carrier layer and a keytop layer. A plurality of electrical connection sites are disposed on the printed circuit board. A plurality of metal domes are correspondingly disposed above the electrical connection sites respectively. When each of the metal domes is pressed, it is electrically connected to the electrical connection site thereunder. The co-molded article includes a PET film and a plunger layer having a plurality of plungers. The co-molded article is allowed to cover the metal domes and to combine the metal domes through an adhesive layer together to attach to the printed circuit board to fix the metal domes on the printed circuit board. The plungers are located above the metal domes respectively. The carrier layer is disposed on the co-molded article. The carrier layer is disposed above the co-molded article. The keytop layer is disposed above the carrier layer, wherein the keytop layer comprises a plurality of keytop components corresponding to the locations of the plungers.

In the present invention, a co-molded article is utilized to serve both functions of a dome sheet and plungers. The co-molded article includes a polymer film and a plunger layer. The plunger layer has a plurality of plungers. The polymer film and the plunger layer may each be extremely thin. Accordingly, the appearance of the keypad can be relatively thin, and it feels uniform upon pressing. Even more, when assembly inaccuracy occurs, it still feels uniform upon pressing the plunger in a certain key range. The click ratio may be maintained in a range of from 30% to 40%. An adhesive layer and a release paper may be disposed on the other side of the polymer film. Such that, after the co-molded article is obtained, it can be ready for attaching the metal domes and the printed circuit layer upon removing off the release paper. The manufacturing process is convenient.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flow chart illustrating a method of making a keypad plunger structure according to an embodiment of the present invention;

FIGS. 2 and 3 are schematic cross-sectional views illustrating making the co-molded article through a co-molding process in the present invention;

FIG. 4 is a flow chart illustrating a method of making a keypad plunger structure according to another embodiment of the present invention;

FIG. 5 is a schematic cross-sectional view illustrating a keypad plunger structure according to an embodiment of the present invention;

FIG. 6 is a flow chart illustrating a method of making a keypad plunger structure according to further another embodiment of the present invention;

FIG. 7 is a schematic cross-sectional view illustrating a keypad plunger structure according to another embodiment of the present invention; and

FIG. 8 is an exploded diagram illustrating the keypad plunger structure as shown in FIG. 7.

### DETAILED DESCRIPTION

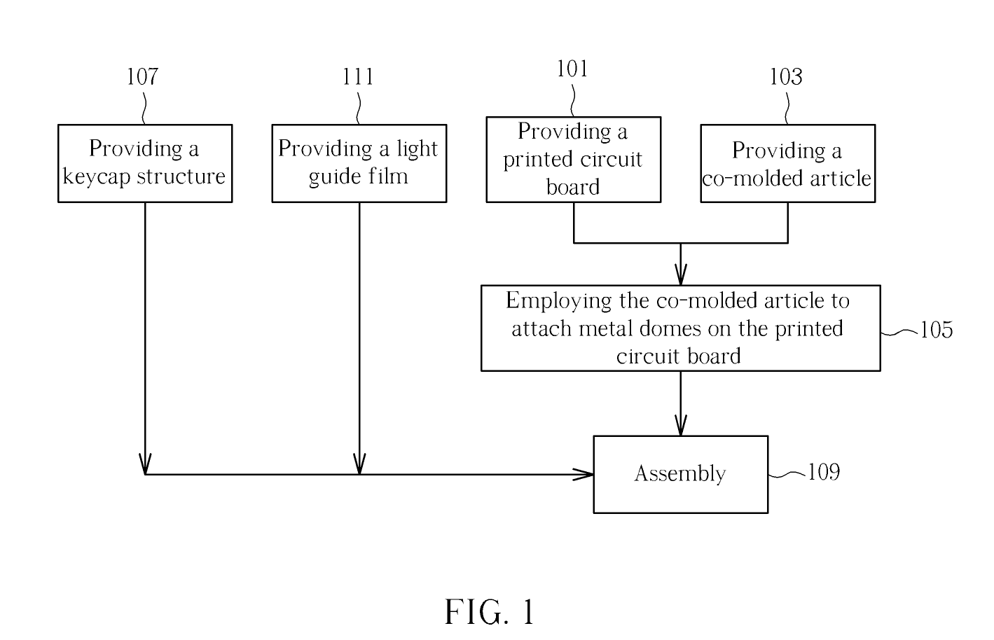

Referring to the flow chart of FIG. 1, a method of making a keypad plunger structure according to an embodiment of the present invention is described. In Step 101, a printed circuit board is provided. In Step 103, a co-molded article is provided. The co-molded article includes a polymer film and a plurality of plungers. The polymer film has a first side and a second side. The plungers are attached to the first side of the polymer film through for example a co-molding process. In Step 105, the co-molded article is employed to attach a plurality of metal domes to the printed circuit board. The plungers are disposed at locations corresponding to the metal domes, respectively. In Step 107, a keycap structure is provided. In Step 109, the keycap structure is disposed above the co-molded article for the assembly. Step 111 may be performed optionally to provide a light guide film. The light guide film may be disposed above the co-molded article, and then the keycap structure is disposed above the light guide film. A light source is disposed at a side of the light guide film. Steps 101, 103, 107, and optional 111 can be performed without limitation to the order. Alternatively, Steps 105, 107, and optional 111 can be performed without limitation to the order.

In one embodiment, the co-molded article may be made as described in the followings. First, an uncured plunger material layer is applied on a side of a polymer film. Next, the polymer film and the plunger material layer are together molded in a die device. The first die of the die device is flat and allowed to face the polymer film side. The second die of the die device has a plurality of recesses each in a shape of plunger and allowed to face the plunger material layer. Accordingly, when the first die and the second die are closed to each other, the second die presses the plunger material film to form a plurality of plunger shapes. After a curing process, for example, a heat curing process, a plunger layer having a plurality of plungers is formed. The plunger layer and the polymer film are directly combined in a co-mold state to give a co-mold article.

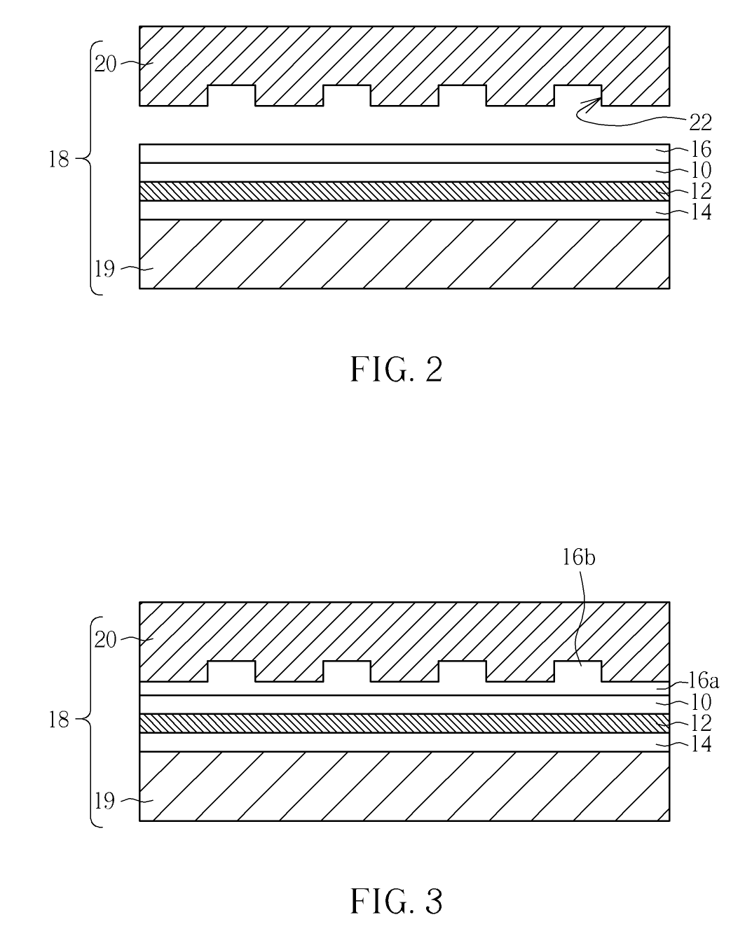

The co-molded article is employed to attach the plurality of metal domes to the printed circuit board. This can be accomplished through combining the co-molded article with the metal domes by an adhesive layer together to attach to the printed circuit board. Thus, after the co-molded article is obtained, one side of the co-molded article is applied with an adhesive material or a double-sided adhesive tape for attachment of the metal domes. Alternatively, when the polymer film is very thin and a support by a carrier layer is required, one side of the polymer film may be attached to an adhesive layer and a release paper in advance, and another side of the polymer film may be applied with a layer of plunger material, and, thereafter, the co-molding process is performed. Alternatively, an adhesive layer having a release paper is directly applied with a layer of polymer to form the polymer film, and then a layer of plunger material is applied to the other side of the polymer film, and, thereafter, the co-molding process is performed. That is, the co-molded article thus formed has one side as the plunger layer and the other side as the release paper. After the release paper is removed, the co-molded article having the adhesive layer thereon can be immediately employed to attach the metal domes on the printed circuit board. It is convenient to prepare the co-molded article in this way, and, besides, the polymer film can be very thin. FIGS. 2 and 3 illustrate an embodiment. One side of a polymer film 10 is attached to an adhesive layer 12 and a release paper 14, and thereafter the other side of the polymer film 10 is applied with a layer of plunger material 16. Then, the polymer film 10 and the layer of plunger material 16 are together placed in the die device 18 including a lower die 19 and an upper die 20 for co-molding. The upper die 20 has a plurality of recesses 22 each in a shape of plunger. As shown in FIG. 3, when the die device 18 closes, the layer of plunger material 16 is molded into plunger shapes, giving a plunger layer 16a. The plunger layer 16a contacts one side of the polymer film 10. It is preferred to allow this side to have a certain thickness in addition to the structure of the plungers 16b, such that the bonding area for co-molding the plungers and the polymer film may increase. This also allows the plunger material to easily fill the recesses 22 during the co-molding process, and the co-molding process can be further reliable.

The thickness of the polymer film may be determined as desired. The material may include for example soft, flexible, or elastic polymer film, such as PET film. The size of the plunger is also determined as desired. The shape may be for example pillar or hemisphere, but not particularly limited thereto. The plunger layer may include for example elastomer material, such as natural rubber or synthetic rubber including for example silicone rubber. In an embodiment for an ultra-thin keypad having a total thickness of for example about 0.3 mm, the PET film may have a thickness of for example about 0.03 mm, the plunger layer may have a thickness of for example about 0.02 mm to about 0.03 mm, the plunger may have a diameter of for example about 1.5 mm to about 2.5 mm, preferably about 2.0 mm in an embodiment of the present invention, and a height of about 0.2 mm to about 0.4 mm, preferably about 0.3 mm in an embodiment of the present invention, and may in a shape of pillar or hemisphere.

In the above method, the keycap structure may include a keycap material as desired, for example, ultraviolet curable resin (UV light curable resin) keycap, injection molded keycap, film in plastic (FIP) keycap, insert-molding decoration (IMD), aluminum, iron, glass, and the like.

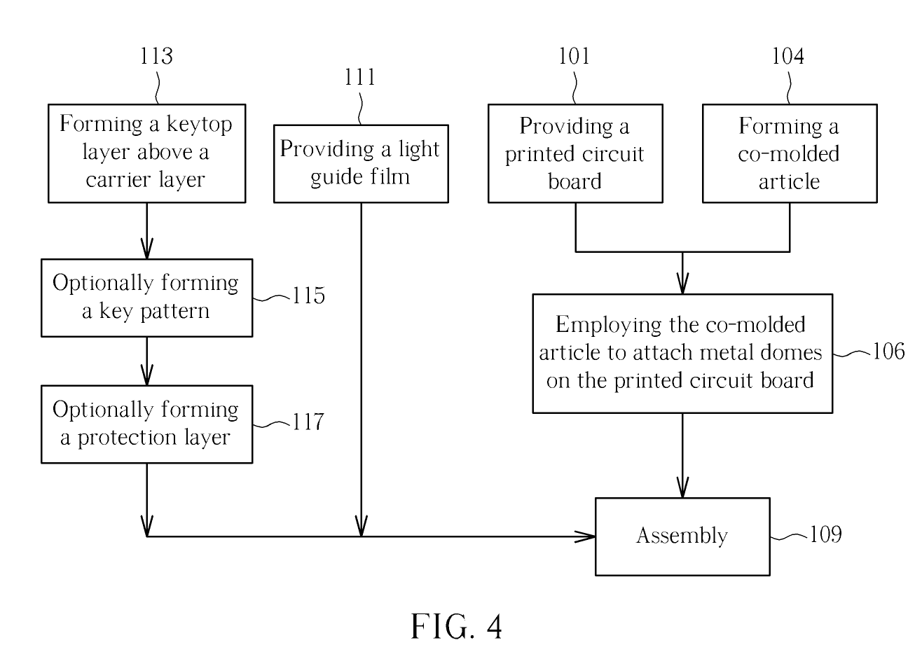

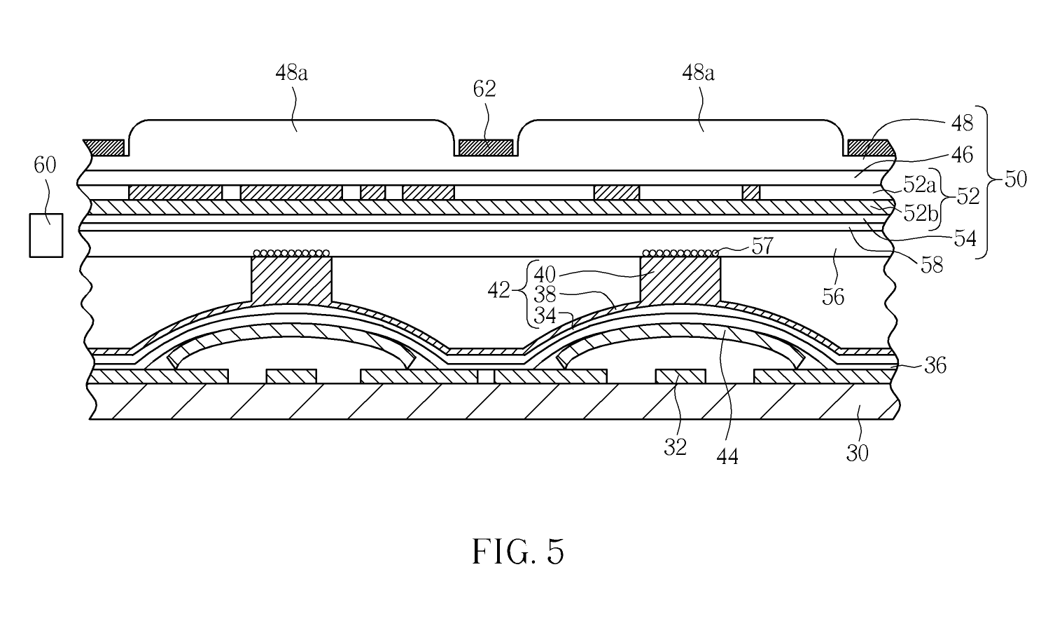

Referring to the flow chart of FIG. 4 and the schematic cross-sectional view of FIG. 5, another embodiment of the method of making a keypad plunger structure is described. Likewise as described above, the formation of the co-molded article, the attachment of the co-molded article to the printed circuit board, the formation of the keycap structure and optionally providing the light guide film can be performed without limitation to the order. It is described in detail as follows. In Step 101, a printed circuit board 30 is provided. A plurality of electrical connection sites 32 are disposed on the printed circuit board 30. In Step 104, a co-molded article is formed. Specifically, an adhesive layer 36 is applied on a side of a PET film 34 and a release paper (not shown) is attached thereto. A silicone rubber layer is applied on another side of the PET film, and a co-molding process is performed the same as described above, to co-mold the silicone rubber layer and the PET film 34. After curing, a plunger layer 38 is formed and has a plurality of plungers, with the PET film 34 together to become a co-molded article 42. In Step 106, the release paper is removed off the co-molded article 42. The co-molded article 42 is employed to attach a plurality of metal domes 44 to the printed circuit board 30 through the adhesive layer 36. The plungers 40 are disposed at locations corresponding to the metal domes 44, respectively. In Step 113, a keytop layer is formed above a carrier layer. Specifically, a UV-light curable resin layer 48 is formed on a carrier layer 46 and a molding process is performed to allow the UV-light curable resin layer to have a shape of a plurality of keytop components 48a. This UV-light curable resin layer is irradiated with a UV light to cure to obtain a keycap structure 50. The carrier layer 46 may include for example PET or polycarbonate (PC).

Step 115 of forming a key pattern may be performed optionally. For example, a printed pattern layer 52 including an expressing layer 52a and a background layer 52b are formed on the carrier layer 46. Step 117 of forming a protection layer 54 for the key pattern may be performed optionally. However, the key pattern is also allowed to be formed at other place of the key and/or using other means, such as printing or engraving on the keytop surface, or other traditional method. In Step 109, the keycap structure 50 is disposed above the co-molded article 42 for the assembly. Furthermore, the keytop components 48a are located correspondingly with respect to the plungers 40. Step 111 may be performed optionally to provide a light guide film 56. The light guide film 56 and the protection layer 54 may be combined with each other by an adhesive layer 58. The light guide film 56 may have fine dots, that is, micro-structures 57, such as printed dots. The printed dots are located in an artwork region. When a light passes the doted region, the micro-structures 57 as optical dots will change light path and refract the light to the artwork region. The light guide film may be for example a silicone film, a polycarbonate (PC) film, a TPU elastomer film or a PET film. A light source 60, such as a light emitting diode (LED) or an ultraviolet-light emitting diode (UV-LED), is disposed at a side of the light guide film 56. If the UV-LED is utilized, a phosphor may be added at a proper position. A housing layer 62 may be further disposed to cover an area among the keytop components 48a of the keycap structure 50. The housing layer has both effects of appearance and light shielding.

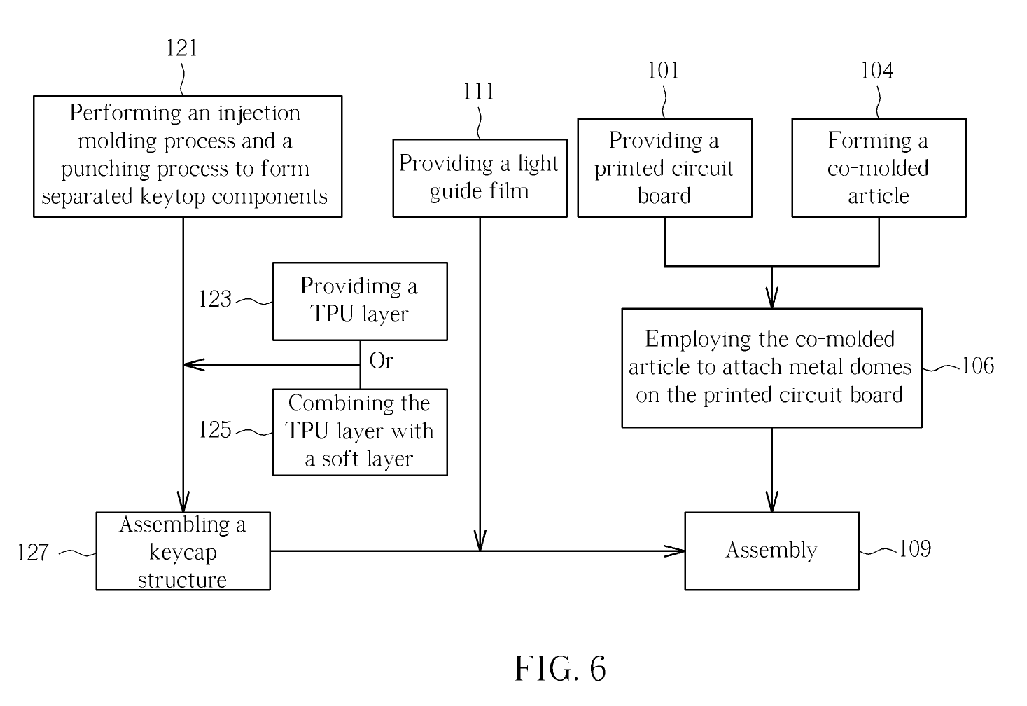

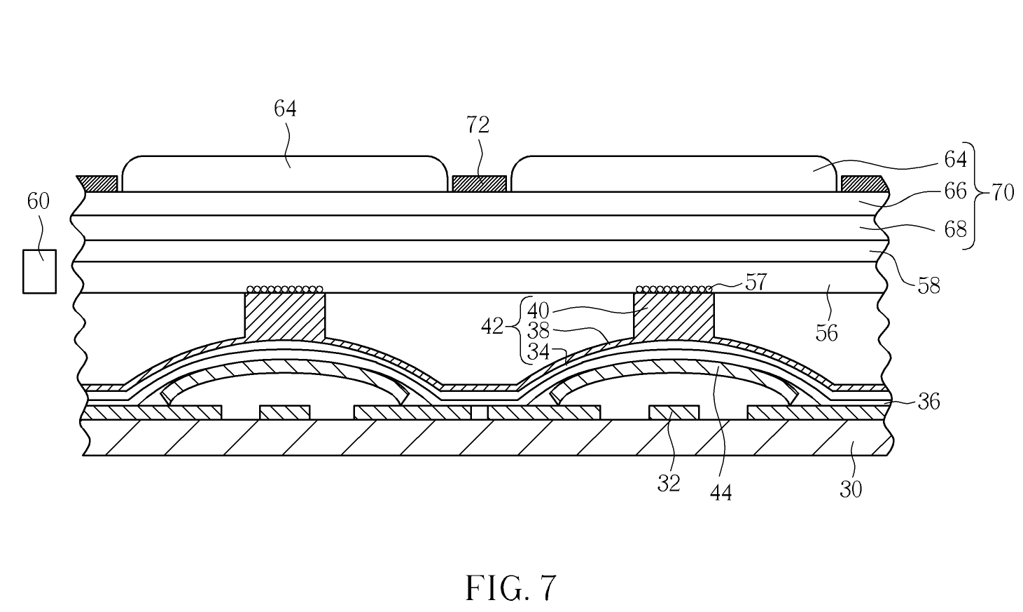

Referring to the flow chart in FIG. 6 and the schematic cross-sectional view of a keypad plunger structure in FIG. 7, further another embodiment of the method of making the keypad plunger structure according to the present invention is described. Likewise as mentioned above, the formation of the co-molded article, the attachment of the co-molded article to the printed circuit board, the formation of the keycap structure and optionally providing the light guide film can be performed without limitation to the order. It is described in detail as follows. In Step 101, a printed circuit board 30 is provided. A plurality of electrical connection sites 32 are disposed on the printed circuit board 30. In Steps 104 and 106, likewise as described above, a co-molded article 42 including a PET film 34 and a plunger layer 38 having a plurality of plungers 40 is formed, and the co-molded article 42 is employed to attach a plurality of metal domes 44 to the printed circuit board 30 through the adhesive layer 36. The plungers 40 are disposed at locations corresponding to the metal domes 44, respectively. Such steps are not repeated for concise. In Step 121, an injection molding process and a punching process are performed on a resin to form a plurality of keytop components 64 in a type of separated key. In Step 123, a TPU layer 66 is provided. Alternatively, in an optional step 125, the TPU layer may be combined with a soft layer. These two layers may be further co-molded into a plurality of key forms, and the keytop components are attached to the key forms, respectively. For example, the TPU layer 66 and a silicone rubber 68 are co-molded. And further in Step 127, a keycap structure is assembled, that is, the keytop components 64 are attached to the TPU layer 66 to form a keycap structure 70. Key patterns may be optionally formed on the keycap structure 70. In Step 109, the keycap structure 70 is disposed above the co-molded article 42 and the keytop components 64 are located correspondingly with respect to the plungers 40. Step 111 as described above may be performed optionally to provide a light guide film 56. A housing layer 72 may be further disposed to cover an area among the keytop components 64 of the keycap structure 70.

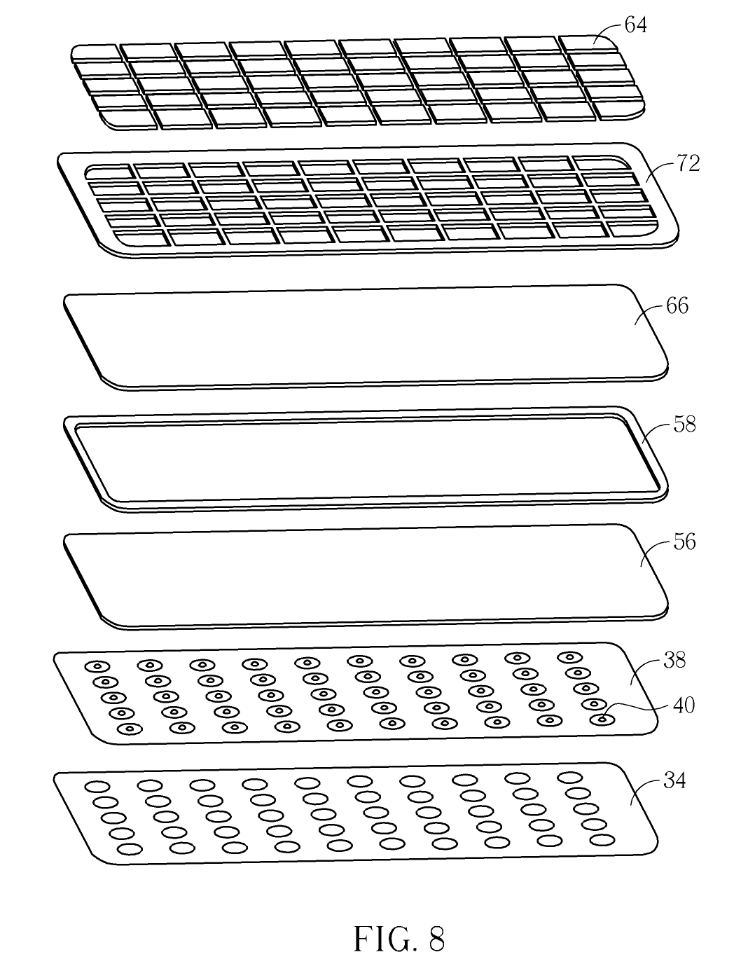

FIG. 8 is a schematic exploded diagram for more specifically illustrating each layer in the keypad plunger structure as shown in FIG. 7. In which, the printed circuit layer 30, the adhesive layer 36, and the silicone rubber layer 68 are not shown.

Those skilled in the art will readily observe that numerous modifications and alterations of the device and method may be made while retaining the teachings of the invention.

What is claimed is:

1. A method of making a keypad plunger structure, comprising:
providing a printed circuit board comprising a plurality of electrical connection sites;
providing a co-molded article comprising a polymer film and a plunger layer comprising a plurality of plungers, wherein, the polymer film has a first side and a second side, and the plunger layer is attached to the first side of the polymer film;
employing the co-molded article to attach a plurality of metal domes to the printed circuit board, wherein the plungers are disposed at locations corresponding to the metal domes, respectively; and
disposing a keycap structure above the co-molded article.

2. The method of making a keypad plunger structure according to claim 1, further comprising disposing a light guide film between the co-molded article and the keycap structure and disposing a light source at a side of the light guide film.

3. The method of making a keypad plunger structure according to claim 1, wherein the co-molded article is allowed to combine the metal domes through an adhesive layer together to attach the metal domes to the printed circuit board.

4. The method of making a keypad plunger structure according to claim 3, wherein the co-molded article is allowed to attach to the metal domes and the printed circuit board through the adhesive layer at the side of the polymer film thereof.

5. The method of making a keypad plunger structure according to claim 3, wherein the co-molded article is allowed to attach to the metal domes and the printed circuit board through the adhesive layer at the side of the plunger layer thereof.

6. The method of making a keypad plunger structure according to claim 1, wherein the co-molded article is provided by steps of:
applying an adhesive layer on a first side of a polyethylene terephthalate film and attaching a release paper thereto, applying a silicone rubber layer on a second side of the polyethylene terephthalate film, and performing a co-molding process to mold the silicone rubber layer into a plurality of plungers, and performing a curing process to obtain the co-molded article; and
removing the release paper off the co-molded article.

7. The method of making a keypad plunger structure according to claim 6, wherein the keycap structure is provided by steps of:
forming a UV-light curable resin layer on a carrier layer, performing a molding process to allow the UV-light curable resin layer to have a plurality of keytop components, and irradiating the UV-light curable resin layer with a UV light for curing to obtain the keycap structure.

8. The method of making a keypad plunger structure according to claim 7, further comprising disposing a light guide film between the co-molded article and the keycap structure and disposing a light source at a side of the light guide film.

9. The method of making a keypad plunger structure according to claim 7, further comprising forming a key pattern on the keycap structure.

10. The method of making a keypad plunger structure according to claim 7, further comprising providing a housing layer to cover an area among the keytop components of the keycap structure.

11. The method of making a keypad plunger structure according to claim 6, wherein the keycap structure is provided by steps of:
performing an injection molding process and a punching process on a resin to form a plurality of keytop components; and
attaching the keytop components to a thermoplastic polyurethane layer to form the keycap structure.

12. The method of making a keypad plunger structure according to claim 11, further comprising disposing a light guide film between the co-molded article and the keycap structure and disposing a light source at a side of the light guide film.

13. The method of making a keypad plunger structure according to claim 11, further comprising forming a key pattern on the keycap structure.

14. The method of making a keypad plunger structure according to claim 11, further comprising providing a housing layer to cover an area among the keytop components of the keycap structure.

15. The method of making a keypad plunger structure according to claim 11, further comprising combining a soft layer with the thermoplastic polyurethane layer under the thermoplastic polyurethane layer.

16. The method of making a keypad plunger structure according to claim 15, wherein the thermoplastic polyurethane layer and the soft layer are co-molded into a plurality of key forms and the keytop components are attached to the key forms.

17. A keypad plunger structure, comprising:
a printed circuit board, wherein a plurality of electrical connection sites are disposed thereon;
a plurality of metal domes correspondingly disposed above the electrical connection sites respectively, wherein, when each of the metal domes is pressed, it is electrically connected to the electrical connection site thereunder;
a co-molded article covering the metal domes and combining the metal domes through an adhesive layer together to attach to the printed circuit board to fix the metal domes on the printed circuit board, wherein, the co-molded article comprises a polyethylene terephthalate film and a plunger layer having a plurality of plungers, and the plungers are located above the metal domes respectively;
a thermoplastic polyurethane layer disposed on the co-molded article; and
a plurality of keytop components attached to the thermoplastic polyurethane layer corresponding to the locations of the plungers.

18. The keypad plunger structure according to claim 17, further comprising a light guide film disposed between the thermoplastic polyurethane and the co-molded article and a light source disposed at a side of the light guide film.

19. The keypad plunger structure according to claim 17, wherein the plungers each comprise a silicone rubber.

20. The keypad plunger structure according to claim 17, further comprising a soft layer disposed between the thermoplastic polyurethane layer and the co-molded article.

21. A keypad plunger structure, comprising:
a printed circuit board, wherein a plurality of electrical connection sites are disposed thereon;
a plurality of metal domes correspondingly disposed above the electrical connection sites respectively, wherein, when each of the metal domes is pressed, it is electrically connected to the electrical connection site thereunder;
a co-molded article covering the metal domes and combining the metal domes through an adhesive layer together to attach to the printed circuit board, wherein, the co-molded article comprises a polyethylene terephthalate film and a plunger film having a plurality of plungers, and the plungers are located above the metal domes respectively;
a carrier layer disposed above the co-molded article; and
a keytop layer disposed above the carrier layer, wherein the keytop layer comprises a plurality of keytop components corresponding to the locations of the plungers.

22. The keypad plunger structure according to claim 21, further comprising a light guide film disposed between the carrier layer and the co-molded article and a light source disposed at a side of the light guide film.

23. The keypad plunger structure according to claim 21, wherein, the plungers each comprise silicone rubber.

24. The keypad plunger structure according to claim 21, wherein, the carrier layer comprises polyethylene terephthalate, and the keytop layer comprises a UV light-cured resin.
